(19) United States
(12) Patent Application Publication
(10) Pub. No.: US 2007/0106736 A1
(43) Pub. Date: May 10, 2007

(54) Variable and customizable email attachments and content

(75) Inventor: Michael D. Shepherd, Ontario, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/272,376

(22) Filed: Nov. 10, 2005

(51) Int. Cl. G06F 15/16

(52) U.S. Cl. 709/206

(57) ABSTRACT

A method for sending electronic mail messages having differing content and attachments associated with the various recipients of the electronic mail message includes composing an electronic mail message and differentiating those component(s) to be sent to the various recipients. Recipient transmittal directions, in the form of electronic mail addresses, aliases, or distribution lists are associated with the differing content and attachments for each recipient. The electronic message is parsed to create an individual message for each recipient, such that each individual message includes a differentiated component(s), and is then transmitted over a computer network to the various recipients.

### CROSS-REFERENCE TO RELATED APPLICATIONS

The following co-pending application, U.S. application Ser. No. 11/146,641, filed Jun. 7, 2005, titled “Email System and Method for Selective Transmission of a Portion of an Email Message”, is assigned to the same assignee of the present application. The entire disclosure of this co-pending application is totally incorporated herein by reference in its entirety.

### BACKGROUND AND SUMMARY

This disclosure relates generally to electronic mail systems and more particularly to systems and methods for associating differing content and attachments to differing recipients of an electronic mail message.

The use of word processing programs and electronic mail systems provides a quick, convenient way for computer users to communicate. Email messages are initiated by a sender, who composes the message using a text editing program and provides a list of recipients, identified in an address line. The sender may also want to include attachments, such as files, folders, pictures, documents, or the like. Attachments are not usually a part of the body of the original email message, but are separately stored and transmitted files that are made up of additional pictures, documents, etc. that are received with the original message. Attachments may be represented by an icon, which must be separately selected and opened. This selection opens a separate window containing the contents of the file forming the attachment, and may require opening a separate application program.

However, the originator of the message may desire to vary email attachments and content by recipient even when much of the message is common and it is most economical to send a single message to those recipients. For example, an originator of an email message may want to send a writable document to one set of recipients and a read-only document to another set of recipients. Other examples that distinguish multiple attachments include varying versions of the same document, a red-lined document and a clean document, software build for release and software build for debug, or simply sending a private document to some recipients and no attachment to others. Currently, a message originator must create multiple email messages customized for content and/or attachments, or expose all content and attachments to all recipients.

Therefore, what is needed is an electronic mail system that allows an originator of an electronic message to associate differing content and/or attachments to differing recipients in an email message. For the reason state above, and for other reasons stated below which will become apparent to those skilled in the art upon reading and understanding the present specification, there is a need in the art for a method of allowing an originator of an email message to vary the content and attachments transmitted to each recipient of a single email message.

All U.S. patents and published U.S. patent applications cited herein are fully incorporated by reference. The following patents or publications are noted:

U.S. Pat. No. 6,775,689 to Raghunandan (“System for Restructuring Selected Parts of Email Messages Prior to Transmission to Plurality of Recipients”) describes a feature in an email editor for sending selected segments of email contents to selected recipients by segmenting the email contents in the body of the email editor into a plurality of segments and identifying in the header of the email editor a recipient list for each segment. To implement this feature, a graphical user interface of a conventional email editor needs to be modified to include new fields in the header for identifying recipient lists for each segment in the body. The graphical user interface of the conventional email editor further needs to be modified to include new fields in the body to associate text/attachments with each segment.

U.S. Pat. No. 6,628,306 to Marchionda (“Email Applications Option to CC: Secondary Recipients without Attachments”) describes an email option that allows a user to “cc:without attachments” an electronic mail message. A sender can send an email message to a primary recipient that includes an attachment and, contemporaneously, send a copy of the original email message to a secondary recipient without including the attachment. In the case of more than one secondary recipient, the user selects which, if any, of the secondary recipients are to receive the email message with the attachment.

U.S. Pat. No. 6,529,942 to Gilbert, (“System and Method for Providing Recipient Specific Formats for Electronic Mail”) teaches embedding processing codes within an email message so that selected text within the message can be changed for specific recipients based upon an identifier code corresponding to each recipient's message. An email message is then created corresponding to each specific recipient after the embedded processing codes have been correlated to each recipient.

The disclosed embodiments provide examples of improved solutions to the problems noted in the above Background discussion and the art cited therein. There is shown in these examples an improved method for sending electronic mail messages having differing content and attachments associated with the various recipients of the electronic mail message. The method includes composing an electronic mail message and differentiating those component(s) to be sent to the various recipients. Recipient transmittal directions, in the form of electronic mail addresses, aliases, or distribution lists are associated with the differing content and attachments for each recipient. The electronic message is parsed to create an individual message for each recipient, such that each individual message includes a differentiated component(s), and is then transmitted over a computer network to the various recipients.

In another embodiment there is provided a system for sending electronic mail messages having differing content and attachments associated with the various recipients of the electronic mail message. The system includes means for composing an electronic mail message and differentiating those component(s) to be sent to the various recipients. Recipient transmittal directions, in the form of electronic mail addresses, aliases, or distribution lists are associated with the differing content and attachments for each recipient. The electronic message is parsed to create an individual message for each recipient, such that each individual message includes a differentiated component(s), and is then transmitted over a computer network to the various recipients.

In yet another embodiment, there is disclosed a computer-readable storage medium having computer readable program embodied in the medium which, when the program code is executed by a computer, causes the computer to perform method steps for sending electronic mail messages to at least one recipient, with differing content and attachments associated with the different recipients of the electronic mail message. The method includes composing an electronic mail message and differentiating those component(s) to be sent to the various recipients. Recipient transmittal directions, in the form of electronic mail addresses, aliases, or distribution lists are associated with the differing content and attachments for each recipient. The electronic message is parsed to create an individual message for each recipient, such that each individual message includes a differentiated component(s), and is then transmitted over a computer network to the various recipients.

### BRIEF DESCRIPTION OF THE DRAWINGS

The foregoing and other features of the embodiments described herein will be apparent and easily understood from a further reading of the specification, claims and by reference to the accompanying drawings in which:

FIG. 1 is a block diagram of an email system capable of associating differing content and/or attachments in an email message;

FIG. 2 is a flow chart illustrating a method for operation of a variable content email client;

FIG. 3 illustrates an email message for a variable content email client;

FIG. 4. is a flow chart illustrating a method for operation of an intermediary variable content service; and

FIG. 5 illustrates an email message for a variable content email client.

### DETAILED DESCRIPTION

In the following detailed description, reference is made to the accompanying drawings, which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the disclosure. The following detailed description is, therefore, not to be taken in a limiting sense.

The method and system described herein provides the capability for associating differing content and/or attachments in transmitted electronic mail messages. While some electronic mail systems permit an originating user to individually customize an electronic mail message for different recipients using a single message (described more fully in U.S. application Ser. No. 11/146,641, filed Jun. 7, 2005, titled “Email System and Method for Selective Transmission of a Portion of an Email Message”), the sender of an email message may desire to associate differing attachments to the various recipients of the email message. Utilizing the message and system herein, a sender of an email message utilizes a specialized variable content email client or variable content intermediary service to split an email message into multiple messages before arriving at a legacy email server. As used herein, variable content refers not only to document attachments and message content, but also any other content such as pictures, audio files, hyperlinks, digitized signatures, and the like.

Various computing environments may incorporate capabilities for supporting an email network. The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

The method and system may also be practiced in distributed computing environments where tasks are performed by remote processing devices that are linked through a communication network. In a distributed computing environment, program modules may be located in both local and remote memory storage devices.

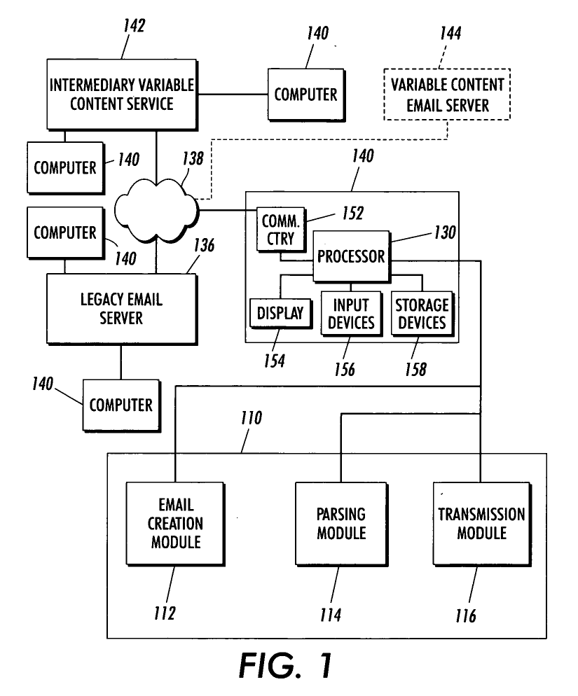

Referring to FIG. 1, the schematic diagram illustrates an example embodiment of the system for providing differing content in email messages. The variable content email client 110 resides on a computer network including a plurality of computers 140 having email software incorporated into each of the computers for sending and receiving email messages through communication network 138. Legacy email server 136 is a typical electronic mail server that receives and routes email from a set of users through network 136. It uses standard email protocols and network connections (such as SMTP over TCP/IP) to perform its service. Intermediary variable content service unit 142 may also be coupled to the computers 140.

The computers 140 typically have a processor 130, random-access memory, read-only memory, and one or more storage devices 158, such as a hard drive, CD-ROM, DVD, diskette, etc., and may include variable content email client 110. The processor 130 is coupled to an output device 154, such as a display device, input devices 156, such as a keyboard, mouse, or pointer, and communication circuitry 152. Output device 154, for example, a monitor, displays information for viewing by a user of computer 140 and input device 156 is used to control a screen pointer provided by the graphical user interface of the operating system. The system and method herein are not limited to any particular output or input device, including telephone and voice mail technology.

As shown in FIG. 1, the computers 140 are coupled together via the network 138. In one embodiment, computer 140 includes a modem and corresponding communication drivers to connect to the Internet via what is known in the art as a “dial-up connection”. In another embodiment, the computers 140 are coupled together in only a local-area network (LAN). In yet another embodiment, the computers 140 include an Ethernet or similar hardware card to connect to the local-area network that itself is connected to the Internet via what is known in the art as a “direct connection”. In further embodiments, the computer 140 may be connected to the Internet using a cable modem or satellite Internet connectivity.

The system and method herein are not limited to a particular type of network system to which the computers 140 are connected. Typical network interfaces include general-purpose systems such as POTS (plain-old telephone systems) and ISDN (Integrated Services Digital Network), as well as special-purpose systems such as a LAN ((local-area network) or a WAN (wide-area network). Such networking environments are commonplace in offices, enterprise-wide computer networks, intranets and the Internet. Those skilled in the art will appreciate that the principles of the system and method described herein can be applied to virtually any network system without departing from the scope of the claims and specification.

Processor 130 communicates with variable content email client 110, which includes email creation module 112, optional parsing module 114, and transmission module 116. For the purposes of this example embodiment, variable content parsing capability resides within intermediary variable content service 142 rather than within variable content email client 110. Email creation module 112 is configured to enable the user to compose an email message for transmission to intermediary variable content service 142. The composed message typically includes text (body of the email message), a subject line, and the identification of recipients (header of the email message), identified by individual email addresses or by email aliases or distribution lists. The designated recipients may have individual email addresses or may belong to different email aliases or distribution lists. In those messages in which the message originator desires to customize a single message for different recipients, the text and optionally the attachments may include designators identifying the message portions/attachments to be transmitted to specific recipients. These designators may be of any form known in the art, for example, the inclusion of additional fields in the text and header sections of the message, identifying symbols, data blocks, or embedded processing codes. The message portions to be transmitted to specific recipients are linked to or associated with email addresses entered in the header segment of the message.

Transmission module 116 is configured to transmit the original email message from variable content email client 110 to intermediary variable content service 142. The modules of email system 110 may also include additional programmable instructions capable of being executed by processor 130 for performing other functions known in the art for conventional email editors or email systems, such as storing contact information, storing sent and received email messages, searching email messages for particular keywords, adding attachments to composed email messages, etc.

Intermediary variable content service 142 enables a user to specify which recipients are to receive certain attachments and/or message body content in the email message through the use of specialized data blocks or other designators placed in the message by the variable email client. When an intermediary variable content service is employed, the variable content email client does not parse the email message prior to transmitting the message to the intermediary variable content service. Instead, the message is sent unparsed and the intermediary variable content service 142 utilizes the specialized data blocks, or other designators identifying the message portions/attachments to be transmitted to specific recipients, to split the message into the appropriate combination of emails.

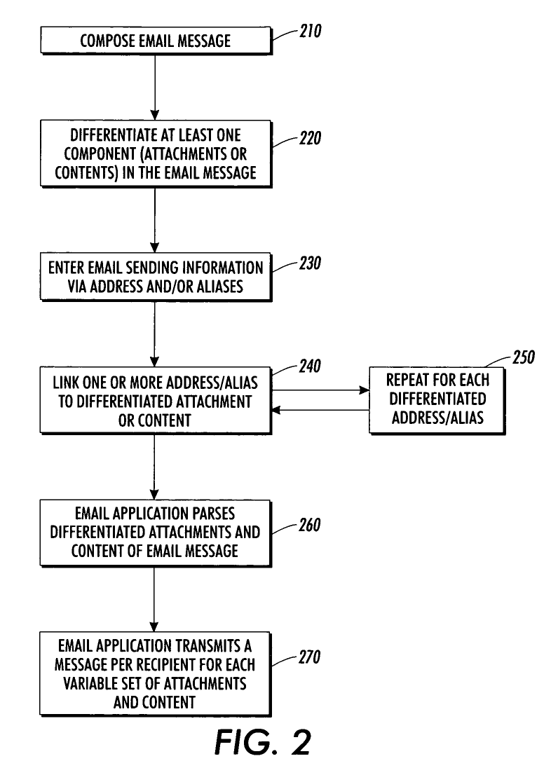

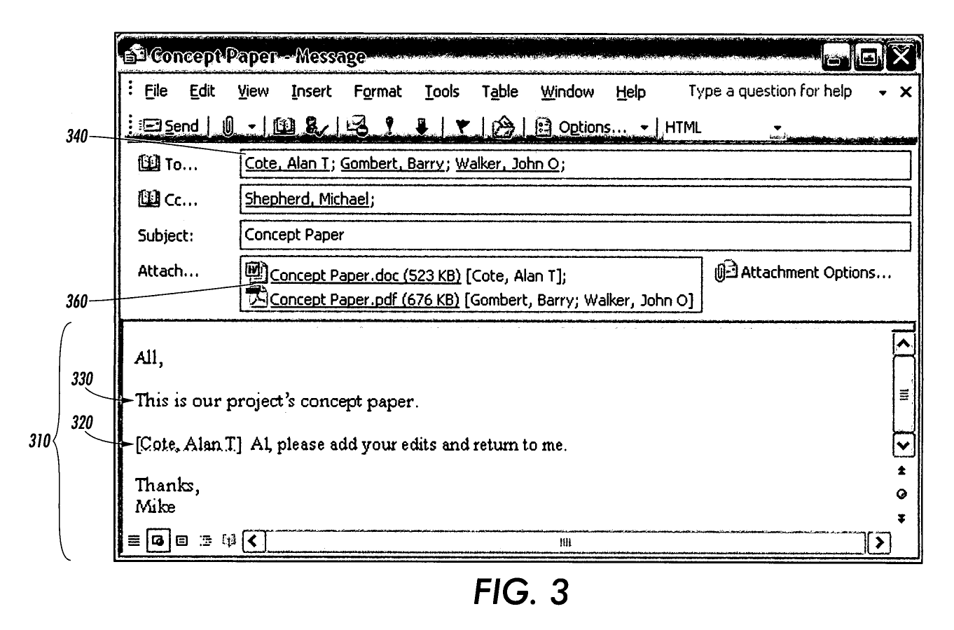

The intermediary variable content service may also apply any rules utilized to discern when, or in what form, a particular attachment should be sent to specific recipients. For example, some recipient addresses may be designated as authorized to receive read-only documents rather than editable documents. The intermediary variable content service then transmits the associated attachments and body content to the legacy email server, which forwards the messages to the specified recipients. This is discussed more fully with reference to FIGS. 2 and 3 hereinbelow. The variable content email message is split into the appropriate combination of email messages with attachments and content and is then provided to legacy email server 136.

Legacy email server 136 receives the email message from the variable content email service 142 and forwards the messages to the specified recipients. Legacy email server generally sends two or more separate e-mails per individual variable content email received from the intermediary variable content service.

In an alternate example embodiment, the system for providing differing content in email messages includes a plurality of computers 140 having email software incorporated into each of the computers for sending and receiving email messages through communication network 138 as described hereinabove with reference to FIG. 1. Optional variable content email server 144 replaces the need for legacy email server 136 and intermediary variable content service 142 by combining the functions of the legacy server and the intermediary variable content service. Computers 140 include processor 130, which communicates with variable content email client 110. In this embodiment the modules of variable content email client 110, which includes email creation module 112 and transmission module 116, function as described above with reference to the discussion of FIG. 1. For the purposes of this example embodiment, variable content parsing capability resides within variable content email server 144 rather than within variable content email client 110.

In another example embodiment, the system for providing differing content in email messages includes a plurality of computers 140 having email software incorporated into each of the computers for sending and receiving email messages through communication network 138 as described hereinabove with reference to FIG. 1. This embodiment also includes legacy email server 136 and variable content email client 110. This example embodiment does not utilize an intermediary variable content service 142 or a variable content email server 144.

Processor 130 communicates with variable content email client 110, which includes email creation module 112, parsing module 114, and transmission module 116. Email creation module 112 is configured to enable the user to compose an email message for transmission to legacy email server 136. The composed message typically includes text (body of the email message), a subject line, and the identification of recipients (header of the email message), identified by individual email addresses or by email aliases or distribution lists. In those messages in which the message originator desires to customize a single message for different recipients, the text and optionally the attachments may include designators identifying the message portions/attachments to be transmitted to specific recipients. These designators may be of any form known in the art, for example, the inclusion of additional fields in the text and header sections of the message, identifying symbols, or embedded processing codes. The message portions to be transmitted to specific recipients are linked to or associated with email addresses entered in the header segment of the message. Variable email content may be expressed via a specialized “variable content” email user interface that supports creation, modification, and destruction of associations between email recipients and attachments.

Parsing module 114 recognizes designators for a specific recipient in email system 110. Upon recognition of the designators, parsing module 114 separates or parses a composed email message to create individualized copies of the original message for each recipient. Email clients may employ rules to discern when particular attachments should be sent to certain recipients. For example, if editable documents are not to be sent from a company to an external source, a read-only document (perhaps in a PDF format) would automatically be sent to those recipients outside the intranet domain. Distillation of the document into a read-only format may occur when the email is transmitted, or prompting may be used to inform the user of the email client to denote the read-only document. Transmission module 116 is configured to transmit the individualized copies of the original message to the legacy server 136, which forwards the messages to the designated recipients. The designated recipients may have individual email addresses or may belong to different email aliases or distribution lists. The modules of email system 110 may also include additional programmable instructions capable of being executed by processor 130 for performing other functions known in the art for conventional email editors or email systems, such as storing contact information, storing sent and received email messages, searching email messages for particular keywords, adding attachments to composed email messages, etc.

The particular methods performed by the system for associating differing content to differing recipients of an email message comprise steps which are described below with reference to a series of flow charts. The flow charts illustrate an embodiment in which the methods constitute computer programs made up of computer-executable instructions. Describing the methods by reference to a flowchart enables one skilled in the art to develop software programs including such instructions to carry out the methods on computing systems. The language used to write such programs can be procedural, such as Fortran, or object based, such as C++. One skilled in the art will realize that variations or combinations of these steps can be made without departing from the scope of the disclosure herein.

Turning now to FIG. 2, there is illustrated one embodiment of the method for providing variable content/attachments to email messages for a plurality of recipients utilizing a variable content email client. The originator of an email message composes the message at 210, which typically includes the body of the message and various attachments. The user is able to differentiate which recipients are to receive specified attachments and/or message body content. At 220, the originator differentiates at least one component in the message body or the attachments. Differentiation may be accomplished in any known manner, for example, by bracketed information such as the name of a recipient, highlighting, codes, etc.

The originator then enters the intended recipients' names via addresses or distribution lists on the email message form at 230. The system then links one or more address or distribution list to the differentiated attachment or content at 240, and this is repeated at 250 for each differentiated address and/or distribution list. The variable content email client parses the differentiated attachments and content of the email message at 260 to enable transmission of associated attachments and body content to specified recipients. The variable content email client may also apply any rules utilized to discern when, or in what form, a particular attachment should be sent to specific recipients. For example, some recipient addresses may be designated as authorized to receive read-only documents rather than editable documents. At 270 the variable content email client transmits a message per recipient for each variable set of attachments and content to a legacy email server, which forwards the messages to the intended recipients. Both the variable content email client and server utilize standard e-mail networking protocols.

This is illustrated in FIG. 3, in which the body 310 of an example email message includes differentiated portion 320 and undifferentiated portion 330. For the purposes of this example only, differentiation is indicated through the use of bracket names. However, it will be appreciated by those skilled in the art that any of numerous techniques could be utilized, including highlighting, symbols, or embedded codes all of which are fully contemplated by the specification and scope of the claims herein. Attachments list 360 includes differentiated attachments, with the differentiations corresponding to recipients included in the address list 340.

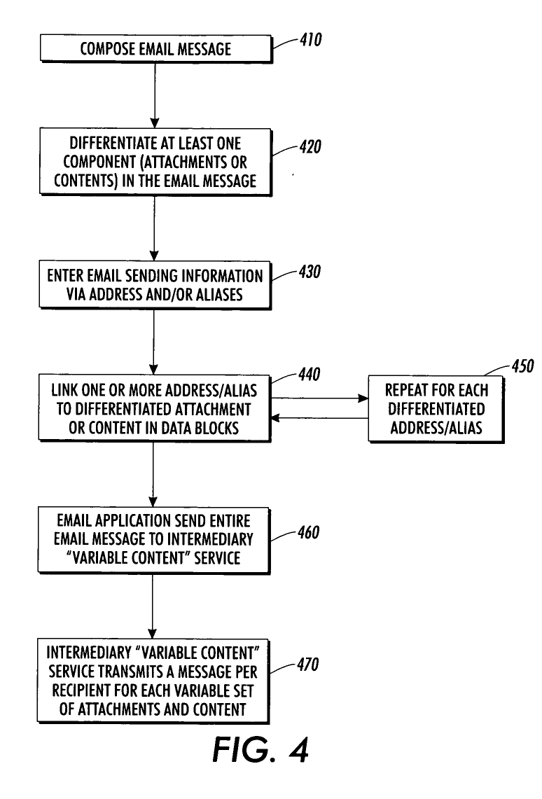

Turning to FIG. 4, there is illustrated an alternate embodiment of the method for providing variable content/attachments to email messages for a plurality of recipients. In this embodiment, a variable content email message is created with specialized data blocks and provided to a variable content intermediary service, which manipulates the specialized data block and splits the message into the appropriate combination of email messages with associated attachments and body content for specified recipients. These messages are then transmitted to a legacy email server, which transmits the messages to the intended recipients. The originator of an email message composes the message at 410, which typically includes the body of the message and various attachments. Utilizing specialized data blocks or other designators, the originator differentiates at least one component in the message body or the attachments at 420. Differentiation through the use of specialized data blocks may be accomplished in any known manner, such as XML, that designate the set of associations between email recipients and attachments/body contents. However, data blocks may not necessarily be pure XML, but may conform to other standards such as RDF (resource definition format) via a table driven representation such as N3. When the variable content intermediary service is utilized, the client application is unaware of variable content capabilities, so the user must learn and appropriately apply these special constructs to denote content variability. One alternative, is for the intermediary variable content service to offer a remote UI (such as via a web page) for the user to have interface prompts for variable content similar to FIG. 3.

The originator then enters the intended recipients' names via addresses or distribution lists on the email message form at 430. The system then links one or more address or distribution list to the differentiated attachment or content at 440, and this is repeated at 450 for each differentiated address and/or distribution list. At 460, the email application transmits the entire email message to an intermediary variable content service. The intermediary variable content service parses the message and discerns when, or in what form, a particular attachment should be sent to specific recipients. For example, some recipient addresses may be designated as authorized to receive read-only documents rather than editable documents. The intermediary variable content service then transmits a message per recipient for each variable set of attachments and content to a legacy email server at 470. It is noted that the e-mail client attaches both a read-only and editable document. The intermediary service does not change the attachments in any way (such as to change a document from editable to read-only). Alternatively, the intermediary service could provide a remote UI (such as on a web page) for the user to compose the variable content e-mail message.

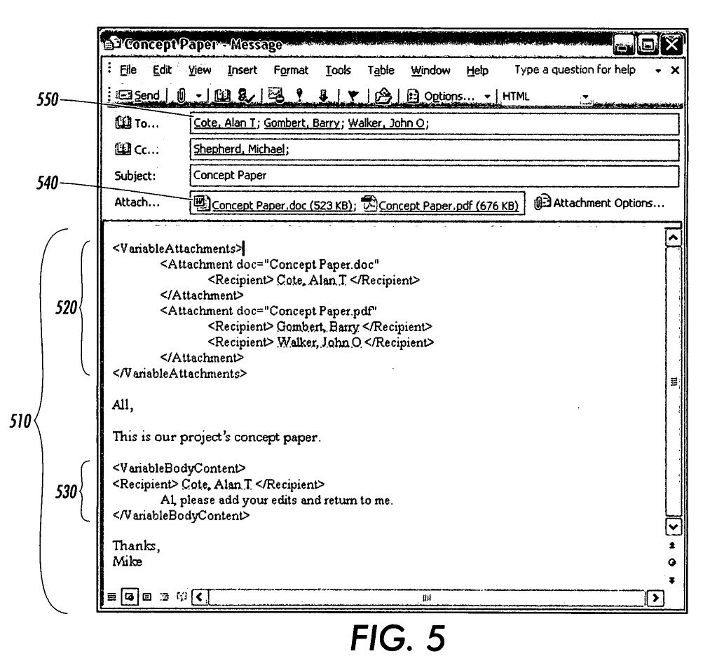

A sample email message for an intermediary variable content service is illustrated in FIG. 5, in which the body 510 of the message includes variable body content 530 and variable attachments 520. In this example, a notation for <variable body content> is included both before and following the portion of the message to be transmitted to specified recipients, with the name of the specified recipient both preceded and followed by the notation <recipient>. Variable attachments are identified in the body of the email message through the notation <variable attachments> preceding and following the group of variable attachments. Each attachment document affected is listed, with the recipient identified with the notation <recipient>. Other notation may be utilized, such as RDF in either XML form or table form. For example:

| | | |
|---|---|---|
| Cote, Alan T | tag: attachment | Concept Paper.doc |
| Gombert, Barry | tag: attachment | Concept Paper.pdf |
| Walker, John | tag: attachment | Concept Paper.pdf |
| Cote, Alan T | tag: content | Al, please add your edits |

All of the attachments, without differentiation indicators, are provided in the attachment list 540, and all intended recipients are included in the list of addressees at 550.

While the present discussion has been illustrated and described with reference to specific embodiments, further modification and improvements will occur to those skilled in the art. For example, the instructions and information for controlling associations between attachments and variable message body content may be included in the e-mail message itself in the case of legacy clients or in either the e-mail message or the e-mail protocol for variable content email clients. The intermediary web service could reside in the variable content email client, in the server, or in a separate module. The intermediary web service may include the capability to use a remote UI (such as a web page) to compose variable content e-mail messages. Additionally, “code” as used herein, or “program” as used herein, is any plurality of binary values or any executable, interpreted or compiled code which can be used by a computer or execution device to perform a task. This code or program can be written in any one of several known computer languages. A “computer”, as used herein, can mean any device which stores, processes, routes, manipulates, or performs like operation on data. It is to be understood, therefore, that this disclosure is not limited to the particular forms illustrated and that it is intended in the appended claims to embrace all alternatives, modifications, and variations which do not depart from the spirit and scope of the embodiments described herein.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for sending electronic mail messages to at least one recipient, wherein differing content and attachments are associated with differing recipients of the electronic mail message, the method comprising:
composing an electronic mail message, wherein said electronic message includes at least two recipients and at least one member selected from the group consisting of message content and attachments;
differentiating at least one component of said electronic mail message, wherein said at least one differentiated component includes at least one member selected from the group consisting of at least one said attachment and at least one portion of said message content;
providing recipient transmittal directions, wherein said transmittal directions may be in the form of at least one electronic mail address, at least one alias, or at least one distribution list for each recipient of said electronic mail message;
associating said recipient transmittal directions with said at least one differentiated component for each recipient of said electronic mail message;
parsing said electronic mail message to create an individual message for each said recipient, wherein each said individual message includes at least one said differentiated component; and
transmitting each said individual message to each said recipient of said electronic mail message.

2. The method for sending electronic mail messages according to claim 1, wherein said attachments include at least one member selected from the group consisting of documents, pictures, audio files, hyperlinks, and digitized signatures.

3. The method for sending electronic mail messages according to claim 1, wherein differentiating at least one component includes providing designators identifying said at least one differentiated component.

4. The method for sending electronic mail messages according to claim 3, wherein said designators include at least one member selected from the group consisting of identifying symbols, data blocks, highlighting, bracketed information, embedded processing codes, or the inclusion of additional fields.

5. The method for sending electronic mail messages according to claim 1, further comprising applying rules discerning when or in what form specific recipients are to receive at least one specified attachment.

6. The method for sending electronic mail messages according to claim 5, wherein said rules include designating specific recipients as authorized to receive read-only documents rather than editable documents.

7. The method for sending electronic mail messages according to claim 1, further comprising utilizing a user interface to create, modify, and destroy associations between said recipient transmittal directions and said at least one differentiated component for each recipient of said electronic mail message.

8. The method for sending electronic mail messages according to claim 1, further comprises at least one member selected from the group consisting of storing contact information, storing sent and received electronic mail messages, searching electronic mail messages for particular keywords, and adding attachment to composed electronic mail messages.

9. The method for sending electronic mail messages according to claim 1, further comprising utilizing a remote user interface to compose said electronic mail message.

10. The method for sending electronic mail messages according to claim 1, wherein associating said recipient transmittal directions with said at least one differentiated component for each recipient of said electronic mail message is controlled by instructions included in said electronic mail message or in an electronic mail protocol.

11. A system for sending electronic mail messages to at least one recipient, wherein differing content and attachments are associated with differing recipients of the electronic mail message, the system comprising:
means for composing an electronic mail message, wherein said electronic message includes at least two recipients and at least one member selected from the group consisting of message content and attachments;
means for differentiating at least one component of said electronic mail message, wherein said at least one differentiated component includes at least one member selected from the group consisting of at least one said attachment and at least one portion of said message content;
means for providing recipient transmittal directions, wherein said transmittal directions may be in the form of at least one electronic mail address, at least one alias, or at least one distribution list for each recipient of said electronic mail message;
means for associating said recipient transmittal directions with said at least one differentiated component for each recipient of said electronic mail message;
means for parsing said electronic mail message to create an individual message for each said recipient, wherein each said individual message includes at least one said differentiated component; and
means for transmitting each said individual message to each said recipient of said electronic mail message.

12. The system for sending electronic mail messages according to claim 11, wherein said attachments include at least one member selected from the group consisting of documents, pictures, audio files, hyperlinks, and digitized signatures.

13. The system for sending electronic mail messages according to claim 11, wherein differentiating at least one component includes providing designators identifying said at least one differentiated component.

14. The system for sending electronic mail messages according to claim 13, wherein said designators include at least one member selected from the group consisting of identifying symbols, data blocks, highlighting, bracketed information, embedded processing codes, or the inclusion of additional fields.

15. The system for sending electronic mail messages according to claim 11, further comprising means for applying rules discerning when or in what form specific recipients are to receive at least one specified attachment.

16. The system for sending electronic mail messages according to claim 15, wherein said rules include designating specific recipients as authorized to receive read-only documents rather than editable documents.

17. The system for sending electronic mail messages according to claim 11, further comprising means for utilizing a user interface to create, modify, and destroy associations between said recipient transmittal directions and said at least one differentiated component for each recipient of said electronic mail message.

18. The system for sending electronic mail messages according to claim 11, further comprises at least one member selected from the group consisting of means for storing contact information, means for storing sent and received electronic mail messages, means for searching electronic mail messages for particular keywords, and means for adding attachment to composed electronic mail messages.

19. The system for sending electronic mail messages according to claim 11, further comprising means for utilizing a remote user interface to compose said electronic mail message.

20. A computer-readable storage medium having computer readable program code embodied in said medium which, when said program code is executed by a computer causes said computer to perform method steps for sending electronic mail messages to at least one recipient, wherein differing content and attachments are associated with differing recipients of the electronic mail message, said method comprising:
composing an electronic mail message, wherein said electronic message includes at least two recipients and at least one member selected from the group consisting of message content and attachments;
differentiating at least one component of said electronic mail message, wherein said at least one differentiated component includes at least one member selected from the group consisting of at least one said attachment and at least one portion of said message content;
providing recipient transmittal directions, wherein said transmittal directions may be in the form of at least one electronic mail address, at least one alias, or at least one distribution list for each recipient of said electronic mail message;
associating said recipient transmittal directions with said at least one differentiated component for each recipient of said electronic mail message;
parsing said electronic mail message to create an individual message for each said recipient, wherein each said individual message includes at least one said differentiated component; and
transmitting each said individual message to each said recipient of said electronic mail message.
